(19) United States
(12) Patent Application Publication
(10) Pub. No.: US 2006/0249948 A1
(43) Pub. Date: Nov. 9, 2006

(54) Scratch-off coating area for application of indicia by users of consumable products

(76) Inventors: Lois P. Kenney, Fullerton, CA (US); James M. Kenney, Fullerton, CA (US)

Correspondence Address: LEONARD TACHNER, A PROFESSIONAL LAW;CORPORATION, 17961 SKY PARK CIRCLE, SUITE 38-E, IRVINE, CA, 92614, US

(21) Appl. No.: 11/285,483

(22) Filed: Nov. 21, 2005

Related U.S. Application Data
(63) Continuation-in-part of application No. 11/124,526, filed on May 9, 2005.

(51) Int. Cl. B42F 21/00

(52) U.S. Cl. 283/36

(57) ABSTRACT

An area on the surface of a bottle of water/soda or can of soda/beer has a coating providing the ability to scratch one's personal identification onto the bottle with a fingernail, e.g. 1″ or 1½″ square area on the surface. The area designated for personal identification would be printed on the bottle, in the packaging operation, similar to a scratch-off area which is commonly found on scratch-off lottery tickets. Of course, the present invention is not limited for use on bottles. Containers having a designated area of scratch-off material could be used on a large variety of consumable products including packaged foods, beer, fast foods, tobacco products, over-the-counter drugs and vitamins and virtually any other product where it would be useful to provide user-applied indicia. An optional additional feature of the present invention comprises a removable tag protectively overlying the scratch-off coating to prevent inadvertent removal of the scratch-off material either before the product reaches the consumer or afterward.

### RELATION TO CORRESPONDING APPLICATIONS

This application is continuation-in-part of patent application Ser. No. 11/124,526 filed on May 9, 2005

### BACKGROUND OF THE INVENTION

1. Field of the Invention

The present invention relates to the field of personal identification areas for permitting consumers of consumable products to conveniently identify a particular product as theirs. More specifically, the invention relates to consumable product containers having a specially designated area with a “scratch-off” material coating to permit a user to conveniently place personal identifying indicia such as name initials on the container to personalize the product or to provide other useful information thereon.

2. Background of the Invention

There has been a substantial increase in recent years in the use of personal size bottles of purified water, soda, sports drinks, beer, etc., especially in portable plastic containers. This increase stems from a number of factors including greater concern about tap water contamination and cross contamination from one person to another, improvements in bottle packaging and materials and larger expenditures by water, soda and drink bottling companies in advertising their products. Consequently, it is today relatively common to observe people carrying a bottle of water, soda or other drink on their person, in their purse or pocket, in their cars, backpacks, briefcases, etc. This is particularly the case in places where people gather such as in sporting events, recreational venues, social functions, gymnasiums and even business meetings and the like.

The invention permits keeping track of each person's bottle of water/soda/beer, etc. One of the problems with carrying a bottle of water/soda, especially when there are other people nearby or in close proximity, especially at work, at the gym or at a party or social gathering, is that, as soon as you put down the bottle of water/soda/beverage, you lose track of it. A substantial percentage of the bottles of water/soda/beverage are wasted, as a person loses track of it or cannot remember which bottle of water/soda/beverage was their bottle of water/soda/beverage. This is especially true when the bottle of water/soda/beverage is taken to the gym or any social function where many people are involved.

This invention prevents the loss of this waste and would more than pay for the cost of the invention. The disclosed solution comprises a blank area on the bottle of water/soda/beverage which is designated for adding one's personal initial or other identification, so that it can be determined whose bottle of water/soda/beverage it is.

It also prevents potential cross contamination of colds and diseases from one person to another, particularly at sporting events, such as, basketball games or practices, where during time out periods, players or participants would replenish fluids. Each person could identify their own bottle of water/soda/beverage.

The idea for a self identification label has been addressed by U.S. Pat. No. 5,154,448, where a label is applied to the surface of a bottle of water, soda or beer; cup or just about any consumable product, etc. The label has an area where a scratch-off material is used to identify the user by etching his/her name into the surface, removing some of the material which exposes a lighter or whiter area underneath the material. This can be a separate label which has the scratch-off material already incorporated into the label or attached to the existing label of the product. This patent satisfies a need for identification of the user of the product. It does not address cost of doing this identification or other means of identification. The addition of a separate label or additional printing on the existing label of the product can be expensive, especially when considering high volume products, such as bottles of water, soda or beer bottles, which are produced at very high speeds on a production manufacturing line.

### SUMMARY OF THE INVENTION

An area on the container of a bottle of water/soda/beverage has a coating providing the ability to scratch one's personal identification onto the bottle with a fingernail, e.g. 1″ or 1½″ square area on the bottle. The area designated for personal identification would be printed directly on the bottle in the packaging operation, similar to a scratch-off area which is commonly found on scratch-off lottery tickets. The coating for the scratch-off area would be provided by the supplier of the filled bottle. Since the bottles are printed by these suppliers, there would be a very minor increase in cost for adding the scratch-off coating to the bottle.

Someone could use a pen or pencil to add this identification to the bottle, but no area on the bottle is currently available on bottles of water/soda to do so, and you have to have a pen or pencil to write your identification on the bottle. This is very inconvenient and, often not practical, especially at certain functions, such as the gym or other sporting event. This invention would give a bottler of water/soda a distinct marketing advantage. Currently, the consumer sees no advantage of buying one bottle of water/soda/beverage over another bottle of water except based on price or due to advertising efforts of the supplier. This invention would differentiate a supplier of bottled water/soda/beverage over another supplier of bottled water/soda, thereby, giving that supplier a sales advantage over the other and thereby potentially increasing sales over the competition.

Of course, the present invention is not limited for use on bottles. Containers having a designated area of scratch-off material could be used on a large variety of consumable products including disposable plastic drinking cups, packaged foods, fast foods, tobacco products, beer, over-the-counter drugs and vitamins and virtually any other product where it would be useful to provide user-applied indicia.

An optional additional feature of the present invention comprises a removable tag protectively overlying the scratch-off coating to prevent inadvertent removal of the scratch-off material either before the product reaches the consumer or afterward.

Reduction of the cost of applying a scratch-off area on the consumable product is the basis of this disclosure. The application of the scratch-off identification must be cost effective in order to be practical with market pressures to reduce costs of the product in today's very competitive world of consumables. Instead of attaching a separate label or imprinting on an existing label of the scratch-off material, which in itself is costly, not taking into consideration the time to apply the label in a high volume production packaging line, the scratch-off material for identification can be imprinted directly onto the surface of the bottle, can or product itself with the use of ink jet printers or transfer printing devices. These devices are prevalent in today's production environment where many or all of consumable products have a date identification system which is imprinted somewhere on the product. There are born-on dates applied to bottles or cans of beer and are advertised for freshness, for example, which are applied by the use of these speedy, high-volume ink jet printers in the production line.

### BRIEF DESCRIPTION OF THE DRAWINGS

The aforementioned objects and advantages of the present invention, as well as additional objects and advantages thereof, will be more fully understood herein after as a result of a detailed description of a preferred embodiment when taken in conjunction with the following drawings in which:

FIG. 1 is a three-dimensional front view of a typical commercial drinking water bottle bearing a scratch-off area according to a preferred embodiment;

FIG. 2 is a rear view of the bottle of FIG. 1;

FIG. 3 is a cross-sectional view of the bottle of FIG. 2 including the area of scratch-off material thereon;

FIG. 4 illustrates the process of a user of the preferred embodiment placing identifying indicia on the bottle;

FIG. 5 shows the result of the process depicted in FIG. 4 and an optional protective tag of the preferred embodiment; and

FIG. 6 is a cross-sectional view taken along lines 6-6 of FIG. 5.

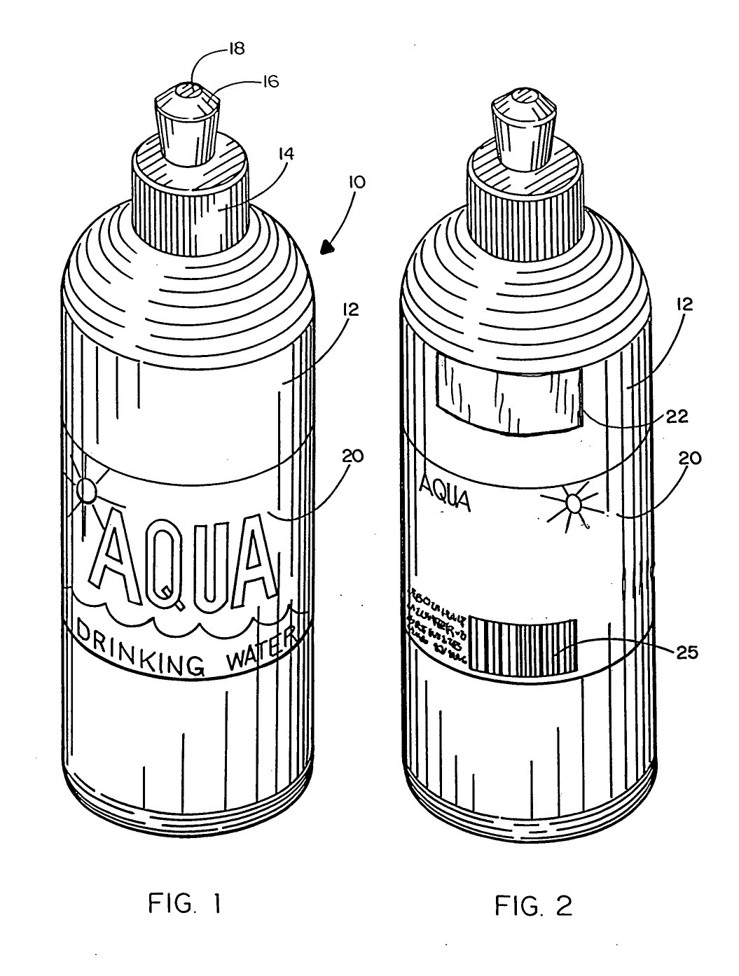

### DETAILED DESCRIPTION OF A PREFERRED EMBODIMENT

Referring to the accompanying drawings, it will be seen that the illustrated embodiment 10 is employed on a typical, commercially available drinking water bottle 12 which is often made of a transparent plastic and provides a threaded cap 14 having a built-in moveable dispenser 16 selectively exposing an orifice 18. A label 20 usually provides the trademark of the bottler as well as required information such as nutrition information, location of manufacturer, etc. The label 20 may also have a UPC code 25 and other information, none of which is particularly relevant to the present invention.

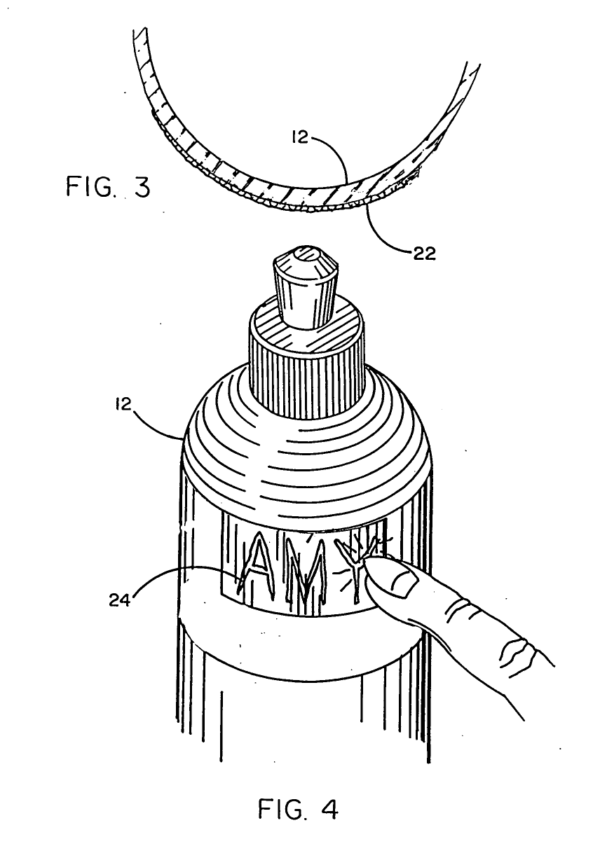

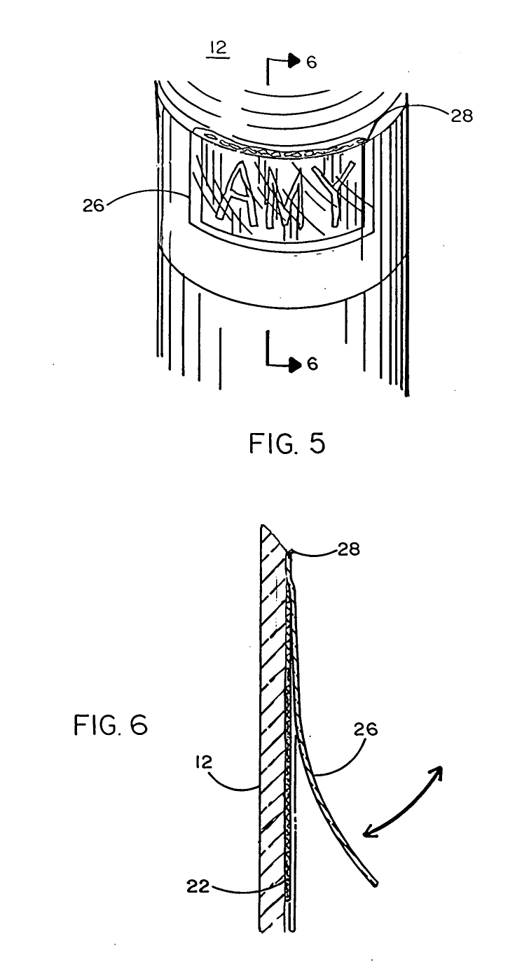

The inventive feature hereof relates primarily to a designated area 22, shown for example in FIGS. 2-6, and which is coated with a scratch-off material. This coating is preferably completely blank and fully intact when a purchaser of the product receives the item from a retailer. Then, as shown best in FIGS. 4 and 5, the purchaser selectively removes portions of the coating such as by use of a fingernail to carefully scrape away some of the coating, to create desired indicia 24. In the illustrated example, the purchaser or user has scratched the letters “AMY” into the coating to uniquely identify that product as belonging to AMY.

It will be understood that the inventive aspect hereof is the provision of an easily removed coating material on an otherwise standard bottle, drink cup or other packaging surface to provide a convenient way to uniquely identify possession of that particular product with indicia formed by selective removal of the coating material. The particular scratch-off material including its adherence to the underlying container surface, its thickness, color and other relevant physical characteristics will be readily apparent to those of skill in the art relating to such coatings. One example of a suitable scratch-off coating is a solvent-based or water-based wax-containing ink applied using a flat bed or rotary silk screen process to a thickness of about 0.5 mils. Suitable coating materials are available from Craig Adhesives and Coatings Company of Newark, N.J. Color of the coating will depend on the bottle color and the nature of the product. A homogenous, opaque white, black or silver colored coating material are probably the most preferred choices, but many different colors are available.

An optional feature of the preferred embodiment is shown in FIGS. 5 and 6. More specifically, the coated area may be covered by a protective flap or tag 26 which may be adhered along a unitary margin 28 to protect the coating before retail sale and protect the identifying indicia 24 after the user scratches them into the coating. The flap or tag 26 is preferably a transparent flexible plastic or if removed by the user; it may be made of an opaque material such as paper or cardboard.

Identifying each item is done by the use of an ink jet printing system which imprints the number, date code, unit number, traceable identification lot number, bar code number, etc. onto the surface of the product. Normally these devices imprint a permanent ink onto the surface of the device which cannot be rubbed off. The ink jet printers spit out an individual dot of ink in high volume and close proximity to each other dot of ink that can be lined up to form a number or other means of identification. Several lines of dots of ink can be lined up, one on top of another to print a square or rectangle of ink with the use of a non-permanent, scratch-off ink. Bar code numbers are just a series of lines that are spaced a certain distance apart to form a special number for inventory purposes, lot identification, product identification, etc. All that is needed is to join or run the dots together instead of spacing them apart to form a block of print. A block of scratch-off ink can be placed just about anywhere on the surface of the bottle, cup, can product etc which would be used for the scratch identification.

There are numerous suppliers of ink jet imprinters on the market which can readily supply the equipment to apply the block of ink for the scratch-off identification area. Some of the suppliers of the printing devices are Foxjet, Markem, Diagraph, Weber Marking System, HP, etc. The list is not all inclusive.

There are also other means of applying the scratch-off ink to the surface of the product. Dry thermal transfer printers are used in packaging applications where speed is not of the essence. These printers are add-on machines to in-line packaging systems which apply the product identification, bar code, lot number, etc. onto the surface of the package material itself. Many food products, for example, are packaged into preformed or formed trays on in-line packaging machines, such as Multivac or Reiser machinery. These machines form a tray or tub into which the product is loaded in line. A top flexible material is sealed onto the formed tray after the product is filled into the tray. The thermal transfer printer then imprints the scratch-off ink onto the surface of the top sealed flexible package material the form of a square or rectangle to be used by the consumer for identification.

There are also other imprinting systems that are available. These are called Micro encapsulated printers (MEP's) which can be used as scratch-off identifying systems. MEP's are used currently in checkbooks where a second page is used for record of use. The second page on a two-page checkbook, records the information regarding the endorsee, amount, data, etc. for future records. MEP is the means of providing the copy. This MEP can also be used for the Scratch ID system. This process can be adapted for commercial use on bottles of water, soda, beer and other commercial beverages. The same process can be used in co-extruded and laminated materials for packaging applications. Co-extrusion or lamination is a process where more than one material is fused or adhesively joined together to provide a stronger finished material, provide better barrier properties, etc. A square rectangle of microencapsulated ink is printed on one surface of the material, then laminated or fused together with one or more layers. The identification can then be scratched through the surface of the top layer, which is transferred to the layer which has the scratch-off ink area, similar to the checkbook where the information is transferred to the secondary surface. The ink would be a different color which would show through the primary surface. This would also provide an area which could not be rubbed off during production or shipping of the product as it is protected by the top layer. Much of the laminated films are reverse printed in this manner to protect the quality of the print from damage.

Having thus disclosed a preferred embodiment, it will now be apparent that many modifications may be made. By way of example, the scratch-off coating may be applied directly to the product or container of the product. Moreover, the nature of the product or container thereof, although primarily intended for consumables, may be virtually any commercial commodity or container thereof including for example, medical supplies and devices, boxed foods, bagged foods, canned foods, consumable liquids of various kinds, tobacco products, beer pharmaceuticals, vitamins, food supplements, fast food containers and package wraps, hardware goods, dairy containers, sports drinks, juices and perishables of all kinds. Moreover, while the emphasis herein is to apply identifying indicia on the coating material, it could also be used by the user to apply other information such as dates, nature of contents (such as paint color on paint cans) and the like.

Accordingly, the scope hereof should be construed in its broadest sense limited only by the appended claims and their equivalents.

We claim:

1. An indexing area on a container of a consumable product, the area comprising:
a selected region designated for use by a consumer of a said product, said region being coated by a scratch-off material selectively removable by a consumer to enable the consumer to create identifying indicia in said designated area.

2. The indexing area recited in claim 1 said scratch-off material being configured for selective removal by a consumer using a fingernail to create said indicia.

3. The indexing area recited in claim 1 wherein said consumable product is taken from the group of products consisting of: bottled water, sodas, fruit juices, sports drinks, alcoholic beverages, milk, iced tea, coffee, packaged sandwiches, boxes of cookies, boxes of donuts, bags of snack foods, packages of potato chips, packages of pretzels, boxes of crackers, tobacco products including cigarettes, cigars, chewing tobacco and pipe tobacco, over-the-counter pharmaceutical products, bottles of vitamins and food supplements and packaged fast food items including hamburgers, chicken pieces and ethnic foods including pizza, burritos and tacos, sandwiches and coffee and other drinks in cups and disposable medical supplies and devices.

4. The indexing area recited in claim 1 further comprising a removable tag protectively overlying said selected area to prevent inadvertent removal of said scratch-off material.

5. An article of manufacture comprising a scratch-off coating applied to a product or container thereof on a designated area and configured for selective removal of a portion of the coating by a purchaser of the product for creating informative indicia thereof after purchasing the product.

6. The scratch-off coating recited in claim 5 further comprising a removable protective flap overlying said designated area for protecting said coating.

7. The scratch-off coating recited in claim 6 wherein said flap is transparent.

8. The scratch-off coating recited in claim 6 wherein said flap is adhered to said product or container along a unitary margin of said flap to permit selective exposure of said designated area to access said coating.

9. An article of manufacture comprising a scratch-off coating applied to a designated area of a container of a product and configured for selective removal of a portion of the coating by a purchaser of the product for creating informative indicia thereon after purchasing the product.

10. The scratch-off coating recited in claim 9 further comprising a removable protective flap overlying said designated area for protecting said coating.

11. The scratch-off coating recited in claim 10 wherein said flap is transparent.

12. The scratch-off coating recited in claim 10 wherein said flap is adhered to said coating along a unitary margin of said flap to permit selective exposure of said designated area to access said coating.

13. A method for providing a scratch-off area on the surface of a container of a consumable product, the scratch-off area permitting a consumer to apply selected indicia using a fingernail; the method comprising the step of printing a scratch-off ink onto a container as an area of contiguous ink droplets placed directly on the surface of the container.

14. The method recited in claim 13 wherein the step of printing is carried out using an ink jet printer.

15. The method recited in claim 13 wherein the step of printing is carried out using a dry thermal transfer printer.

16. The method recited in claim 13 wherein the step of printing is carried out using a micro-encapsulated printer.

17. The method recited in claim 13 wherein the step of printing is carried out on a plastic bottled water container during the filling and capping process.
